(19) United States
(12) Patent Application Publication
(10) Pub. No.: US 2007/0181548 A1
(43) Pub. Date: Aug. 9, 2007

(54) Welding process

(75) Inventors: Ahmed Kaddani, Viisteras (SE); Jan Smede, Viisteras (SE); Dick Skarin, Eskilstuna (SE)

Correspondence Address: VENABLE LLP, P.O. BOX 34385, WASHINGTON, DC, 20043-9998, US

(73) Assignee: ABB AB, Vasteras (SE)

(21) Appl. No.: 10/558,386

(22) PCT Filed: May 28, 2004
(86) PCT No.: PCT/SE04/00834

§ 371 Date: Jan. 19, 2007

(30) Foreign Application Priority Data
Jun. 13, 2003 (SE) 0301753-0

(51) Int. Cl. B23K 9/10

(52) U.S. Cl. 219/130.21

(57) ABSTRACT

An arc welding system including an electric circuit including a power source, a welding torch with a consumable welding wire, a workpiece and a control system including a computer, memory and elements for tuning the arc welding system.

### TECHNICAL FIELD

The present invention concerns a device and a method for tuning an arc welding system. More precisely the invention concerns a device and a method for tuning the arc welding system by using a simulation model of the arc welding process. In particular the invention concerns an arc welding system further including an industrial robot for holding and operating the welding torch. The invention also concerns a computer program product.

### BACKGROUND OF THE INVENTION

In an arc welding process an electrical arc is established between a continuously fed consumable electrode and the base metal to be welded. Energy from the arc is used to melt the base metal and the electrode. Droplets form on the tip of the molten electrode and are transferred across the arc. An inert or slightly reactive shielding gas is provided in the arc region to reduce the reaction of the base metal, molten electrode, and arc due to contamination by the atmosphere. A power source is used to hold the arc voltage or current constant for a given electrode feed rate via an internal feedback control. Disturbances in the arc region such as shielding gas contamination, weld pool interference, and excessive melt-through can be detected in the current and voltage signals as the power source compensates for these events.

Electric arc welding is a complicated process and the resulting deposition of molten metal into a weld pool for performing the welding operation is determined by a tremendous number of interrelated and non-interrelated parameters. These parameters affect the deposition rate, the spatter and debris around the welding operation, the shape and appearance of the weld bead, and the location and quality of the protective slag, to name just a few. The welding process is controlled by the protective gas composition, its flow rate, torch design, the welding torch angle, welding tip design, the size and shape of the deposition groove, control apparatus used in the welding process, amount of stick-out, wire feed speed, speed of the torch along the workpiece, smoke extraction, type of grounding contact on the workpiece, atmospheric conditions, the composition of the workpiece and other variables.

Consequently, arc welding has been largely a trial and error procedure with the ability of the welder to use the appropriate settings for obtaining consistent welds. Each time one of the parameters is changed, the appearance, size, shape, contour, chemistry and mechanical properties of the resulting weld is affected. For this reason, arc welding is a very complex science. Today trained welding engineers are required to provide the desired results. Most systems employ electrical welding parameters at the welder itself, such as a closed loop control based upon arc voltage, arc current or pulse settings. The settings of voltage, current or pulse size or rate are controlled by the welding engineer or by the technician for generating the desired welding. There is no procedure in the art which controls an arc welding process ad hoc without the intervention of the welder or welding engineer. Consequently, in high production arc welding the weld is controlled by adjusting various primary parameters and disregarding the less meaningful parameters.

Arc welding systems comprising a controllable manipulator or an industrial robot are widely used in the industry. In such a process the robot is programmed to follow a desired path to be welded with the welding torch being held at a specified distance. Before the welding process starts the electric circuit, the movement of the robot and the arc welding process parameters must be tuned to achieve optimum quality and productivity.

Since the arc welding is such a complicated process and dependent on a tremendous number of parameters, that sometimes is interrelated but more often is non-related, the process is often divided into a tuning process and a welding control process. The tuning process is thus performed in advance and seeks to evaluate and define values for all parameters that have an influence on the welding quality. Most of these values depend on the welding situation such as the electrical circuit of the welding apparatus and on the properties of the shielding gas and the workpiece to be welded. Thus the workpiece can be determined by parameters of plate thickness, material, type of weld, and so on. The welding apparatus can be determined by the power source, inductance and resistance of the electric circuit and so on. A plurality of these parameters can be calculated or measured in advance. A grater part of these parameters cannot be determined beforehand and therefore have to be given fictive values in order to stabilize the welding apparatus. From U.S. Pat No. 6,096,994 an automatic welding condition setting method and apparatus is previously known. The object of the apparatus is to provide means for setting a welding operation condition, which can be easily used to set a welding operation for a work setting and for a welding objective by a beginner. Thus the apparatus comprises a welding information recording portion for recording welding operation information as well as welding object information. The method discloses means for setting a welding condition by calculating the welding condition in an arc welding comprising the steps of setting a welding machine characteristic parameter and/or a welding machine characteristic expression, setting a welding cross sectional area, setting a correction value determined by each of the elements in a welding, setting a thrown metal amount from some of the welding elements and the welding machine characteristic parameter and/or the welding machine characteristic expression, setting a deposited metal amount from some of the welding elements, and calculating a welding condition by means of supposing that a value obtained by multiplying the deposited metal amount by the correction value and the thrown metal amount have the relation of an equality.

In this method the wire feed speed is adjusted in such a manner that the obtained welding condition becomes within an allowable range of the welding current or/and an allowable range of the heat input. The welding machine characteristic parameter and/or the welding machine characteristic expression are set by supposing that the relation among the welding current, the welding wire melting speed and the welding voltage is the parameter and/or the characteristic expression. The welding cross sectional area is determined by a welding element such as a joint shape, a thickness of a base metal or the like. A correction value is determined by a welding element such as a joint shape, a thickness of a base metal, a material of a base metal, an attitude of a work, a gap amount of a work, a material of a welding wire or the like. A welding demand element such as a bead width, a penetration depth, an amount of an reinforcement, a leg length or the like, the thrown metal amount is determined by the welding current, a welding wire melting speed, a diameter of a welding wire or the like. The deposited metal amount is determined by the welding cross sectional area and the welding speed.

The apparatus and the method described in the known patent document is thus built on simple presumptions of the behavior of the welding operation. The method is aimed for labour welding and does not include any means for predicting the result. From WO 02/078891 a method for controlling an arc welding equipment is previously known. A first object of the method is to control an arc welding equipment by enabling the equipment to be controlled during a welding operation by adjusting at least one welding parameter determined without the need of measurements of the welding process or repeated welding experiments prior to welding. The method is also used for simulating a welding process and for predicting the quality of a weld under the same circumstances.

The method disclosed in the document involves the step of dividing the welding process into at least two parts, representing each part and an associated parameter by a model component, putting the model components and a model powers source in an electric circuit model, and calculating electric circuit model parameters related to the welding parameters. By this method it is possible to determine at least one welding parameter value, such as the welding current or the voltage supply, wire feed rate, wire extension, and use this welding parameter value for controlling the arc welding equipment in accordance with the present conditions to obtain a weld with the desired properties.

The main idea of the method is to obtain the value of at least one welding parameter by means of a theoretical model and use said at least one welding parameter in operating an arc welding equipment and/or in predicting the quality of a weld obtained from an arc welding operation. This is performed by dividing the welding process into parts in the theoretical model and letting each of these welding process parts and the welding parameters associated therewith be represented by a model component. The components are then put in an electric circuit model together with a model power source with the purpose of calculating at least one electric circuit model parameter related to said at least one welding parameter from the electric circuit model. The components may be resistive and/or inductive components, but also other electric elements than pure resistors and inductors may be included in the electric circuit model.

The known method for controlling an arc welding equipment is based on a model of a robotic arc welding process prediction. The methodology involves practical experience and experimental measurements. However these measurements and experiences for creating the model are made on one welding station only. Thus, in a attempt to achieve even better means for tuning an arbitrary arc welding system there is a need for further development of the simulation model approach.

### SUMMARY OF THE INVENTION

A primary object of the present invention is to provide a welding system in which the welding station is tunable to achieve a predetermined quality of the weld of a welded joint in an easy, reliable and less time consuming way. A second object of the invention is to provide a welding system involving a simulation model of an arc welding process in order to produce tuning parameter values by which the actual welding station is accurately tunable beforehand to reach the predetermined quality.

These objects are achieved according to the present invention by a method according to the features in the characterizing part of the independent claim 1 and by a welding system according to the features in the characterizing part of the independent claim 5. Preferred embodiments are described in the dependent claims.

According to a first aspect of the invention the objects are achieved by a method of tuning an arc welding station wherein the tuning parameter values are calculated from a simulation model of an arc welding system and that the simulation model is calibrated to represent the actual welding station.

The simulation model is built on a combination of practical and theoretical knowledge about the welding process and contains components representing the electric circuit, the power source and the metal transfer from the electrode to the workpiece in the arc region. A main component is a model of the electric circuit. In close interaction therewith the simulating model comprises model components containing properties of the cables, the power source, the wire, the workpiece, the weld profile and a model component containing the arc including metal transfer between the wire and the workpiece. All model components, such as electrical circuit, the wire, the arc, the work piece and weld profile are grouped in one computer based system.

The use of a simulation model in order to produce parameter values for tuning a welding station does not, however, take into account properties of the welding system that are related to the actual welding station on site. Thus influences of contact properties, damaged cables, and cables making loops, and the properties of the power source in use are not accounted for in a simulation model. The model therefore has to be calibrated to represent the actual welding station accurately. This is done according to the invention by determining input parameters for a welding simulation model by measurement of such properties of the actual welding station on site.

According to a second aspect of the invention the objects are achieved by an arc welding system comprising welding station with an electric circuit including a power source, a wire feed system and a workpiece. The welding system also comprises a control system including a processor and means for tuning the arc welding system. The tuning means comprises a simulation model of an arc welding system, means for receiving calibration parameter values to calibrate the simulation model, means for calculating the tuning parameter values, and means for implementing these values into the control system

The properties of the model component for the cables are easily detectable from the length and the cross section of the cables. However, these values are sensitive to the final result of the welding operation. From geometrical properties only no affect can be accounted for concerning damages of the cable, connection deviations and the cables interacting with other surrounding objects. Therefore, according to the invention these input system parameters must be measured on site and implemented into the simulation model in order to calibrate the simulation model to the actual welding situation. The calibration of the simulation model to represent the actual welding station would result in achieving better quality of the welded joint.

Arc welding involves a metal transfer from the wire to the workpiece comprising three main parts. The first part comprises the metal evaporation close to the electrode. In this region the gradients of temperature is high and the concentration of molten particles is dense. In this region and the voltage drop is high and the local thermodynamic properties are not in balance. The second part comprises the arc column itself, which occupies most of the space between the electrode wire and the workpiece. In this region the system is in local thermodynamic balance and the voltage drop is low. The third part comprises the behavior of the metal condensation in the region close to the second electrode. In this region the gradients of temperature is also high and the concentration of molten particles is dense. The local thermodynamic properties are not in balance neither in this region and the voltage drop is high.

The simulation model according to the present invention includes model components of the metal transport behavior of each of the first part, the second part and the third part. All components are interactively composed in the simulation model. By feeding into this model system input values of the actual welding system and the actual welding conditions the evaluation of the model produces parameter values by which the system is tuned.

According to the invention the calibration is performed by measurement of a plurality of system parameter values, such as properties of the electric circuit, the arc, the power source and conditions of the actual weld situation, which are fed into the simulation model of the arc welding system. As a result the simulation model will be adopted to represent the actual welding situation on site. Parameter values for tuning the system for the actual arc welding process are calculated from the model. After tuning the system the arc welding process is performed by adaptively controlling the process. To this end a plurality of synergic lines, which describe the dependence between voltage and wire feed rate for different conditions is easily derived from the model.

A synergic case is based on a combination of method, material, wire dimension, gas and wire feed speed. Based on these settings the simulation model, based on the power source weld data unit, calculates the settings for the additional schedule components to be used in the selected method. When this combination has been defined, the main ruling data component is the wire feed speed. The welding voltage value is defined according to the synergic line for the chosen combination. The welding voltage can then be adjusted in a positive or a negative direction outgoing from the synergic line. The default value for the welding voltage is zero volts. That means that the system is working on the predefined synergic line.

In a preferred embodiment of the invention the calibration of the model is performed by a static calibration process. In this process the electric properties of the welding system being first determined by measurement of the electric system with the wire electrode in short circuit contact with the workpiece. By performing a measurement of the short circuited electric system the influence of the arc is eliminated. By empowering the short circuited electric circuit of the arc welding system with a small current the properties, such as inductances and resistances of the electrode circuit and the workpiece circuit is calculated. This process only needs to be performed once and need not to be performed again until anything in the electric circuit has changed, such as the replacement of a cable or the like.

In a further preferred embodiment of the invention the calibration is additionally performed by a dynamic calibration process. In this further process additional properties of the welding station on site is measured with the station being powered and producing an arc. The voltage and current of the electric circuit are then measured for different process modes (for instance spray-arc, short-arc or rapid arc etc). The measured voltages and currents are then compared with the corresponding voltages and currents produced from the simulation model. By application of a correlated rule system the model is further calibrated for dynamic effect of the welding station on site. The dynamic calibration needs to be performed only once.

In a further preferred embodiment of the present invention the calibration is additionally performed by determine the “finger prints” of the power source. Each power source has a dynamic way of operation. Thus the power source “has its own life” and compensates for excess current or voltages as well as for voltage drops. In order to find out the behavior of the power source in the actual welding station these dynamic properties has to be defmed and adopted to the simulation model.

By calibrating the simulating model both statically and dynamically as well as by the behavior of the power source the tuning parameter values determined by the model will make the welding system producing welded joint with a very high quality. By the calibrated model it is also possible to accurately predict the quality beforehand.

By experience a plurality of synergic lines of the wire feed rate (wfr) and the voltage (V) over the electrodes are known. Each synergic line is dependent upon a plurality of other parameters of the hardware properties of the welding situation. Such properties are the behavior of the power source, the properties of the electric circuit, the thickness of the base plate, the type of weld to be performed and other properties. Thus when all properties have been introduced into the simulation model, all parameters for tuning the system will be derived from the model. The process thus involves means to choose the best synergic lines for tuning the speed of the wire feed according to the voltage of the power source.

In an arc welding, there are different known metal transfer modes, such as short-arc mode, spray-arc mode, globular mode, pulsed-arc mode and rapid-arc mode. In a typical short-arc mode, there are at leas t three distinctive phases of operation. In a first phase the tip of the welding wire is at distance from the workpiece. The arc is burning and a droplet is formed on the tip of the wire. In this phase there is no contact between the droplet and the workpiece. As the droplet grow the free distance between the droplet and the workpiece decrease. The arc voltage is therefore decreasing in this phase.

In a second phase the droplet has filled the space between the welding wire and the work-piece thus creating a short cut. Thus the arc voltage is almost zero. In a third phase the droplet has left the wire and is spreading on the workpiece. In this phase the arc voltage is at highest. Thus from determining the arc voltage the welding process can be adaptively controlled. Process controlling parameters comprises wire feed rate (wfr), current (A) and welding speed (ws).

When the welding speed increases there is within the first phase a second behavior that comprises a plurality of droplets in the gap between the welding wire and the workpiece. In an instant moment the plurality of droplets will cause a direct contact between the welding wire and the workpiece. This will create a short cut of the electric system resulting in a low arc voltage. In another instant moment the total free gap between the droplets in the space between the wire and the workpiece will be short thus resulting in a somewhat higher arc voltage.

From the determined properties of the circuit one of the synergic lines is chosen for the process. From the chosen synergic line other process parameters such as wire feed rate, current and welding speed is determined. If any part of the electric circuit is exchanged or performing differently a new calibration is performed. The new calibration will produce new values for the input parameters in the simulation model. Thus the calibration will adopt the model to represent the new welding situation. The calibration of the model will results in performing very accurate tuning parameter values for the arc welding process.

The welding system also comprises computer means for performing the calibration and for controlling the welding process as well as memory means for storing synergic lines and other process data as well as programs carrying instruction for the computer means to carry out the calibration and the process control. The calibration and tuning procedure result in a time saving and a material saving. The method is applicable on any power source. When atomizing the calibration procedure the arc welding process will also be easy to use.

### BRIEF DESCRIPTION OF THE DRAWINGS

Other features and advantages of the present invention will become more apparent to a person skilled in the art from the following detailed description in conjunction with the appended drawings in which:

FIG. 1 is an arc welding system comprising an industrial robot,

FIG. 2 is an electric circuit of a typical welding system,

FIG. 3 is a simulation model of the arc welding system,

FIG. 4 is a model component of the arc region,

FIG. 5 is a diagram of different synergic lines,

FIG. 6 is a diagram of the three phases of welding operation.

FIG. 7 is a detailed picture of a welding system, and

FIG. 8 is a diagram showing measured and predicted curves of I and U.

### DETAILED DESCRIPTION OF THE INVENTION

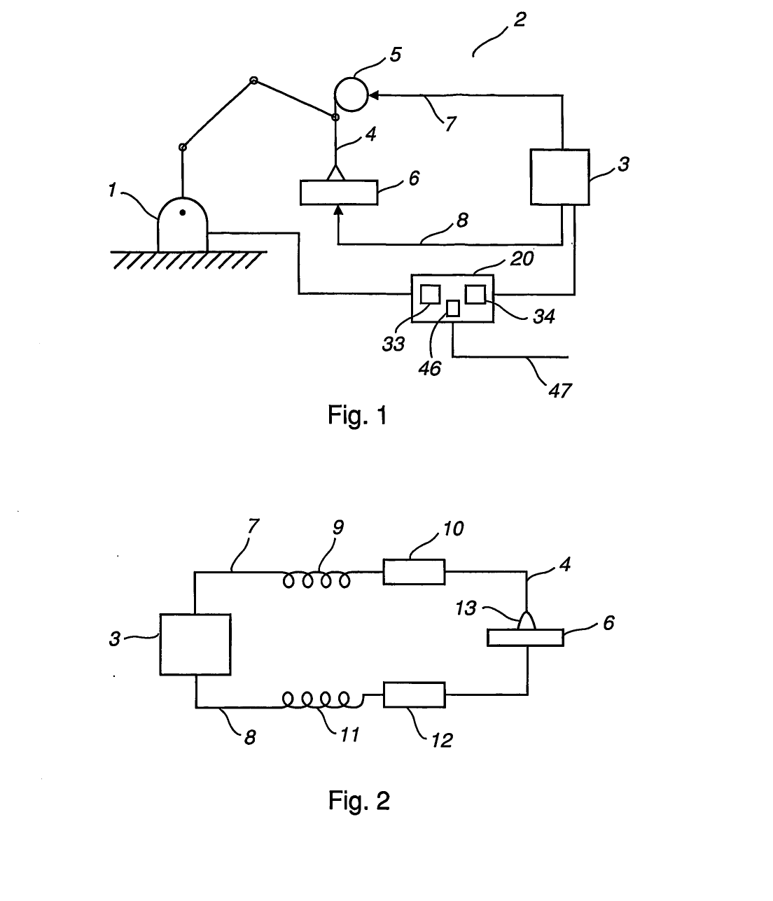

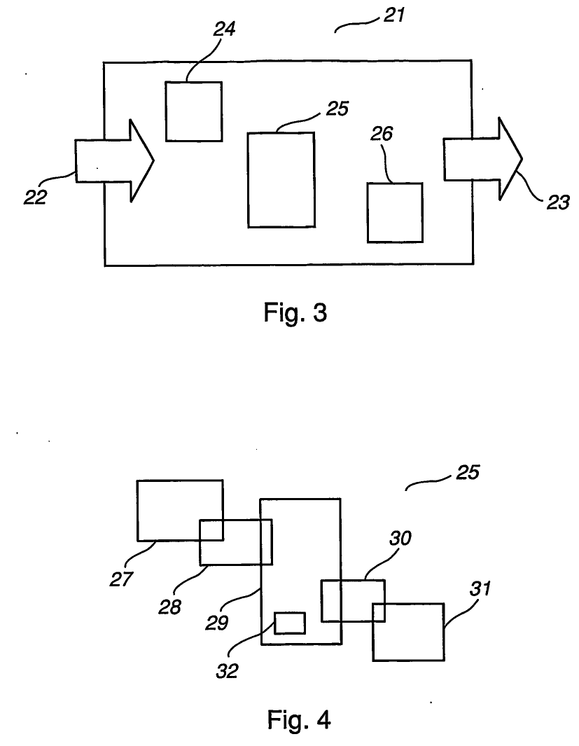

An arc welding system comprises according to FIG. 1 an industrial robot 1 and a electric circuit 2. The electric circuit comprise s a power source 3, a welding torch 4, a welding wire magazine 5 and a workpiece 6. The power source is connected to the torch with a first electric path 7. The power source is connected to the workpiece with a second path 8. When welding there is between the torch and the workpiece an arc 13. The arc welding system also comprises a control system 20 including processor means 33 and memory means 34 for storing data and a computer program. The control system comprises a simulation model of the arc welding system, means for tuning the welding system and input means (46) for receiving simulation model calibration parameter values. The control system also includes as shown in the figure a connection link (47) for data exchange and communication with another computer driven unit or a network, such as the Internet.

The electric circuit is shown in more detail in FIG. 2. Using the same numbers as in FIG. 1 there is a power source 3 with a first electric path 7 and a second electric path 8. The first electric path involves a cable that comprises an first inductance 9 and a first resistance 10. In the same way the second electric path involves a second inductance 11 and a second resistance 12. The first electric path ends with a welding torch 4 and the second electric path ends with a workpiece 6. In welding operation there is an arc 13 between the torch and the workpiece.

A simulation model 21 of the arc welding system according to the invention is shown in FIG. 4. The model comprises an input module 22 and an output module 23. The input module comprises means for receiving system input parameters and information of the robot, the torch, the geometrical and material properties of the workpiece and the electrode, and angles of the torch. The output module comprises means for controlling the process including tuning of the welding system, means for predicting the result of the weld, and means for evaluating the quality of the weld. The model also comprises a model component of the electric circuit 24, a model component of the metal transport in the arc region 25 and a model component of the power source 26.

The model component 25 of the metal transfer of the simulation model is further explored in FIG. 4. The model component comprises three main parts; a model part of the wire 27, a model part of the arc region 29 and a model part of the workpiece 31. Connecting and interacting with these main model parts are a model part of the wire-arc interaction behavior 28 and a model part of the arc-workpiece interaction behavior 31. The model component also include a model part of the influence from the shielding gas 32 that surround the electrode. All these model part are erected from physical behavior of the arc.

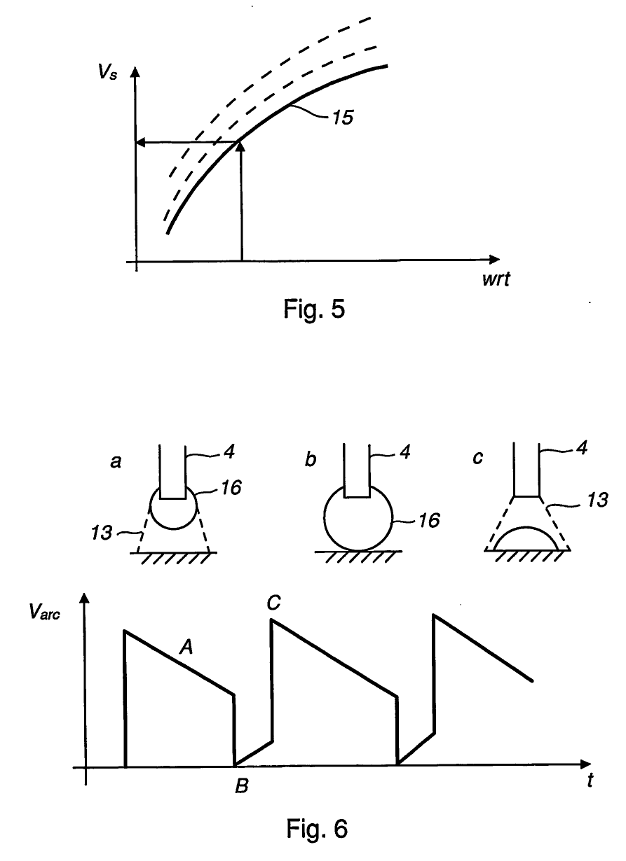

From numerous experiments it is known certain properties between the power supply voltage, Vₛ, and the welding wire feed rate, wfr, as shown in FIG. 5. These properties represent for different conditions of the welding process different synergic lines 15. That is when these parameters from the welding process is known a desired synergic line is chosen, by which the properties between the voltage and the wire feed rate is decided.

FIG. 6 shows three common phases of a welding process. In a first phase a the tip of the welding wire is at distance from the workpiece. The arc 13 is burning and a droplet 16 is formed on the tip of the wire 4. In this phase there is no contact between the droplet 16 and the workpiece 6. As the free distance between the droplet and the workpiece decrease the arc voltage V_{arc} is also decreasing in this phase as denoted with A in the diagram.

In the second phase b the droplet 16 has growing bigger and finally makes contact with the workpiece. When the droplet fill the distance between the wire and the workpiece the electric circuit is short circuited and the arc voltage is almost zero. This is shown in the diagram by the point B.

In the third phase 4c the droplet has left the wire and is spreading on the workpiece. In this phase the arc voltage is at highest and denoted by point C in the diagram.

When the welding speed increases there is within the first phase a second behavior that comprises a plurality of droplets in the gap between the welding wire and the workpiece.

In an instant moment the plurality of droplets will cause a direct contact between the welding wire and the workpiece. This will create a short cut of the electric system resulting in no arc voltage. In another instant moment the total free gap between the droplets in the space between the wire and the workpiece will be short thus resulting in a low arc voltage

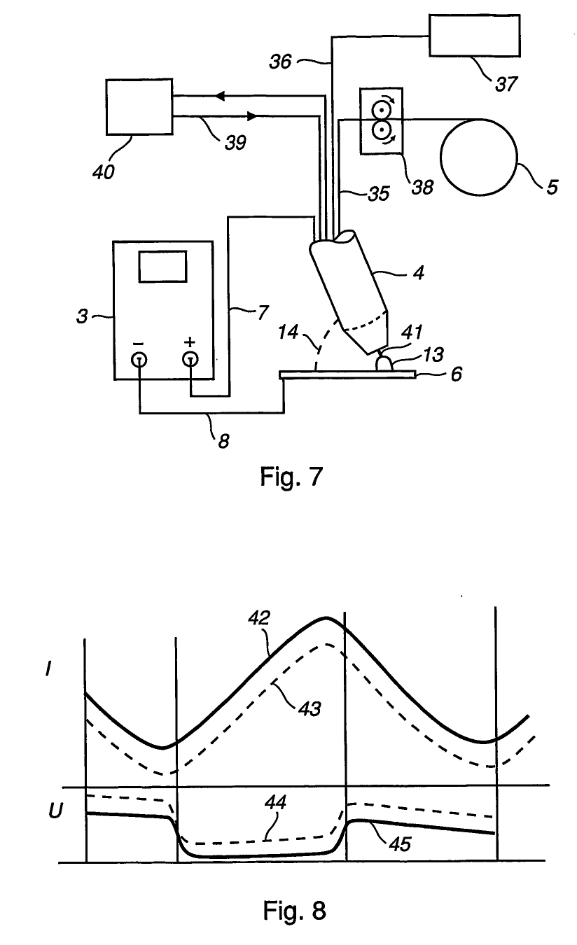

In FIG. 7 the torch region of the welding system is showed in more detail. Using the same denotations as above there is a power source 3 with a first connection path 7 to the welding torch 4 and a second connection path to the workpiece 6. Through the center of the torch 4 is passing a welding wire 35 from a wire magazine 5. The wire is passing through the torch at a predetermined speed controlled by a wire feeder 38. On the front side of the torch an arc 13 is present between the tip 41 of the welding wire and the workpiece 6. Co-axially with the welding wire a shielding gas 36 is passing through the torch from a shielding gas container 37. The welding system comprises a cooling system for cooling of the torch including a cooling media 39 and a cooling media storage 40. The cooling media is circulating through the torch. The cooling media may be any convenient fluid such as water and the like. The cooling system may also comprise a closed loop interacting with a heat exchanger.

To adequately represent the actual welding station on site the simulation model must be calibrated. In a first calibration mode this is achieved by a static calibration. In this calibration mode the arc is short circuited by a link 14 from the torch to the workpiece. The electric system is then powered with a small, controllable current whereby the inductance 9 (FIG. 2) and the resistance 10 of the first path 7, and the inductance 11 and the resistance 12 of second path 8 is calculated The simulation model is then adjusted for these measured parameter values.

In a second mode the simulation model is calibrated by a dynamic calibration. In this calibration the welding station is full powered and an arc is present between the tip of the electrode and the workpiece. The current through the first path 7 and second path 8 and the voltage over these paths is measured in this process mode. A typical representation of such measurement is shown in FIG. 8. In the top section of the diagram in FIG. 8 a measured current 42 is shown together with a current 43 calculated from the no calibrated simulation model. In the lower section of the diagram in FIG. 8 a measured voltage 45 is shown together with a calculated voltage from the no calibrated simulation model. The simulation model is thereafter calibrated whereby the simulated currents and voltages matches the measured equivalents.

In a third mode of calibration the simulation model is calibrated for the actual behavior of the power source in use. In this calibration mode the current and voltage are measures in the electric circuit outside the power source for a plurality of process modes. By this calibration mode the “finger prints” of the power source are determined and implemented into the simulation model. Measurements to determine parameter values for the second and the third calibration mode is preferably performed at the same time.

Although preferred the scope of the invention is not restricted to the embodiments shown in the figures but may within the inventive thought cover also other not shown aspects of the invention.

1. A method of tuning an arc welding system comprising an electric circuit including a power source, and a control system including computer means and memory means, the method comprising:
determining values of system input parameters of the electric circuit;
calculating tuning parameter values from these system input parameters by using a simulation model of the arc welding system; and
tuning the arc welding system by implementing the tuning parameter values into the control system,
wherein the simulation model is calibrated to represent the actual welding situation by measurement of model parameter values on the welding station on site.

2. A method according to claim 1, wherein the calibration comprises a first calibration mode comprising:
short-circuiting the electric circuit over the arc;
sending a controllable current and voltage through the system; and
measuring the resistances and the inductances of the electric circuit.

3. A method according to claim 1, wherein the calibration comprises a second calibration mode comprising:
empowering the welding station with full power to produce an arc;
measuring the current and the voltage (45) of the electric circuit; and
adjusting the model so that predicted values match the measured values.

4. A method according to claim 1, wherein the calibration comprises a third calibration mode comprising:
empowering the welding station with full power to produce an arc;
performing a plurality of process modes by the control unit; and
extracting the characteristic fingerprint pattern of the power source from measurement of current and voltage under each of the performed process modes.

5. A method according to claim 1, wherein the simulation model is brought to comprise a model component of the metal transport between the electrode and the workpiece, the metal transport model is brought to comprise a first model part of a region close to the wire, a second model part of the arc column, and a third model part of the metal condensing in the region close to the workpiece.

6. An welding system, comprising:
an electric circuit including a power source;
a welding torch with a consumable welding wire;
a workpiece; and
a control system comprising computer means, memory means, means for tuning the arc welding system, a simulation model of the arc welding system, means for calibrating the simulation model, input means for receiving measured model parameter values, means for calculating tuning parameter values, and means for implementing these parameter values into the control system.

7. An arc welding system according to claim 6, wherein the arc welding system comprises an industrial robot for operating the torch.

8. An arc welding system according to claim 6, wherein the model parameters of the electric circuit comprise inductance and resistance of a first electric path, inductance and resistance of a second electric path, current and voltage of a process mode, and a correspondent behavior of the power source.

9. An arc welding system according to claim 6, wherein the control system comprises computer means for controlling the welding process, and memory means for storing a plurality of synergic lines.

10. A computer program product comprising instructions to influence a processor to perform a method according to claim 1.

11. The computer program product according to claim 10 provided at least in part over a network such as the Internet.

12. A computer readable medium containing a computer program according to claim 10.
